(19) United States
(12) Patent Application Publication
(10) Pub. No.: US 2016/0343412 A1
(43) Pub. Date: Nov. 24, 2016

(54) MOUNTING APPARATUS FOR STORAGE DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: KAI HONG, Wuhan (CN); SONG DENG, Wuhan (CN); CHIN-PIN HSU, New Taipei (TW); HUAN DENG, Wuhan (CN); LI ZHANG, Wuhan (CN)

(21) Appl. No.: 14/735,913

(22) Filed: Jun. 10, 2015

(30) Foreign Application Priority Data
May 22, 2015 (CN) 201510265282.2

(51) Int. Cl. G11B 33/02

(52) U.S. Cl. CPC G11B 33/027

(57) ABSTRACT

A mounting apparatus for a storage device includes a mounting tray, a bracket and a sliding member received in the bracket. The mounting tray includes a mounting plate. The bracket is secured to the mounting plate and used to secure the storage device. A securing member is located on the storage device, and a clipping member is located on the bracket. The sliding member is received in the bracket and is slidably located between the bracket and the mounting tray. The sliding member is slidable by the storage device relative to the mounting plate, to engage the securing member with the clipping member.

### FIELD

The subject matter herein generally relates to a mounting apparatus for mounting a storage device.

### BACKGROUND

Many electronic devices, such as All-In-ONEs, include data storage devices such as hard disk drives (HDDs), floppy disk drives, and compact disc-read only memory (CD-ROM) drives.

### BRIEF DESCRIPTION OF THE DRAWINGS

Implementations of the present technology will now be described, by way of example only, with reference to the attached figures.

FIG. 1 is an exploded, isometric view of an embodiment of a mounting apparatus.

FIG. 2 is similar to FIG. 1, but viewed from a different angle.

FIG. 3 is an isometric view of the mounting apparatus of FIG. 1 used in an electronic device.

FIG. 4 is similar to FIG. 3, the storage device being out of the electronic device.

FIG. 5 is an assembled view of the mounting apparatus of FIG. 1.

FIG. 6 is a cutaway view of the mounting apparatus of FIG. 1 used in the electronic device.

FIG. 7 is similar to FIG. 5, but viewed from a different angle, and a securing member of the storage device is engaged with a clipping member of a bracket.

FIG. 8 is similar to FIG. 7, and the storage device is not in the mounting apparatus of FIG. 1.

FIG. 9 is similar to FIG. 7, and the securing member of the storage device is disengaged from the clipping member of the bracket.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a mounting apparatus. The mounting apparatus includes a mounting tray, a bracket, and a sliding member received in the bracket. The mounting tray includes a mounting plate. The bracket is secured to the mounting plate and used to secure a storage device. A securing member is located on the storage device, and a clipping member is located on the bracket. The sliding member is received in the bracket and is slidably located between the bracket and the mounting tray. The sliding member is slidable by the storage device relative to the mounting plate to engage the securing member with the clipping member.

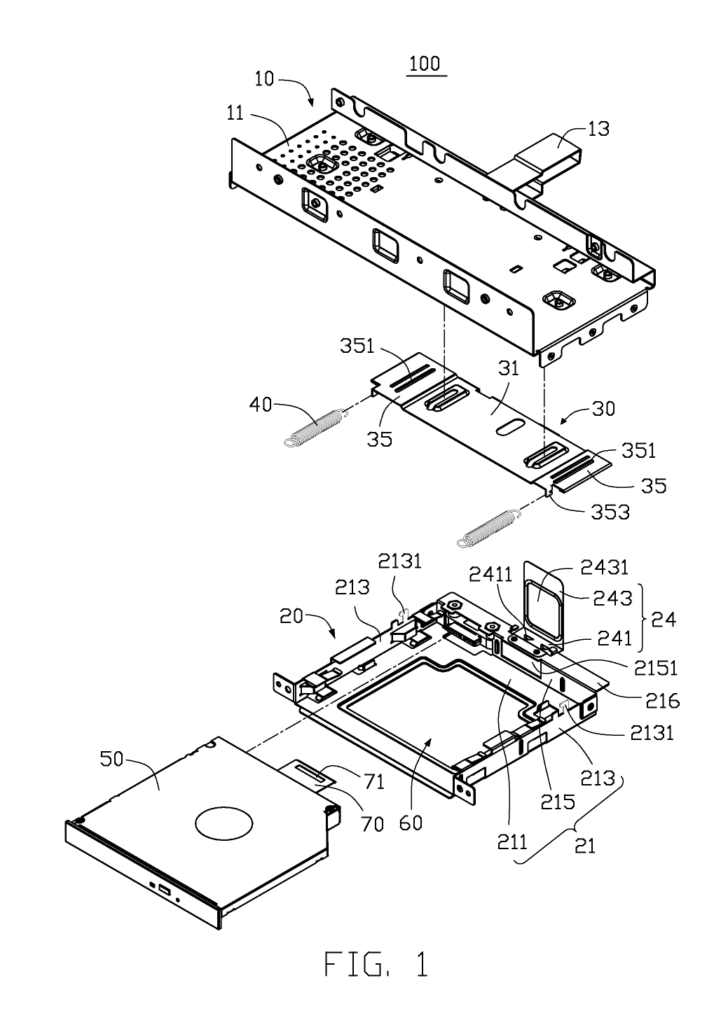

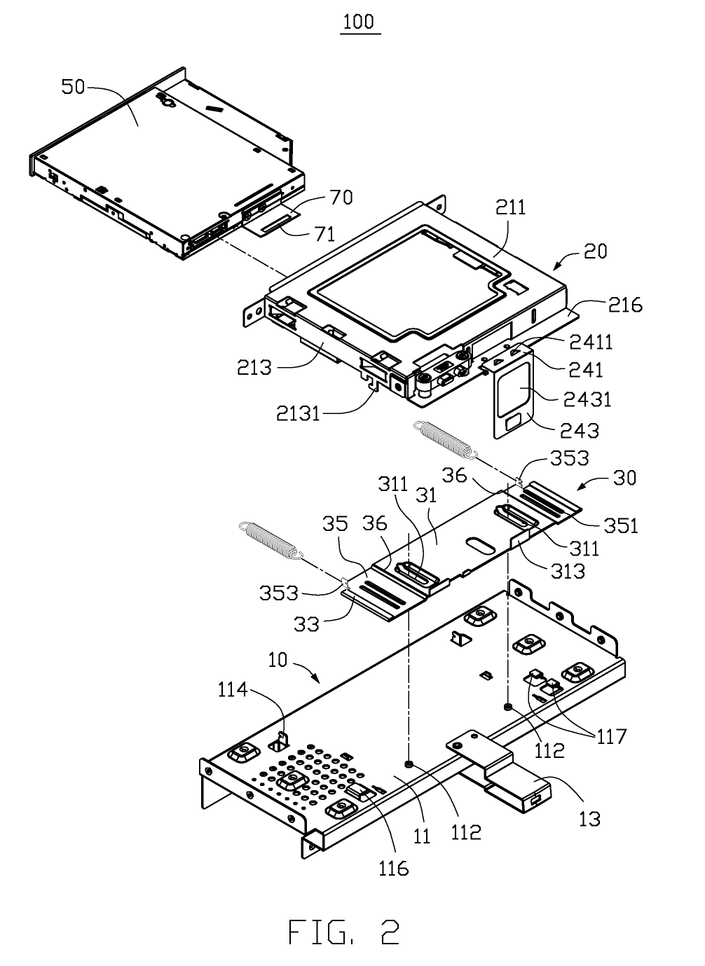

FIGS. 1 and 2 illustrate an embodiment of a mounting apparatus 100. The mounting apparatus 100 can include a mounting tray 10, a bracket 20, a sliding member 30 slidably located between the bracket 20 and the mounting tray 10, and two resilient members 40. The bracket 20 is configured to secure a storage device 50. In at least one embodiment, the storage device 50 can be a hard disk drive (HDD), a floppy disk drive, or a compact disc-read only memory (CD-ROM) drive.

The mounting tray 10 can include a mounting plate 11 and a limiting member 13 secured to the mounting plate 11. Two protruding posts 112, two first hooks 114, two first limiting portions 116, and two second limiting portions 117 are located on the mounting plate 11. In at least one embodiment, each of the two first limiting portions 116 and the two second limiting portions 117 are substantially L-shaped.

The bracket 20 can include a main body 21 and a clipping member 24 secured to the main body 21. The main body 21 can include a bottom plate 211, two side plates 213 extending from opposite edges of the bottom plate 211, and a rear plate 215. The bottom plate 211, the two side plates 213, and the rear plate 215 cooperatively define a receiving space 60 configured for receiving the storage device 50. A sliding piece 2131 extends from each side plate 213. A through hole 2151 is defined in the rear plate 215, and an extending plate 216 extends outwardly from the rear plate 215 and is substantially parallel to the bottom plate 211.

The clipping member 24 is secured to the extending plate 216 by means such as screws, jointing, or clips. In at least one embodiment, the clipping member 24 can be integrated with the extending plate 216. The clipping member 24 can include a clipping piece 241 and an operating piece 243 coupled to the clipping piece 241. In at least one embodiment, the clipping piece 243 is substantially perpendicular to the clipping piece 241. Two clipping portions 2411 are located on the clipping piece 241, and a limiting hole 2431 is defined in the operating piece 243 configured for receiving the limiting member 13.

The sliding member 30 can include a base plate 31, two flanges 33, and a coupling plate 35 coupled to each flange 33 and the base plate 31. A guiding way 36 is defined the base plate 31 and in each coupling plate 35. In at least one embodiment, each flange 33 is substantially perpendicular to each coupling plate 35, and each coupling plate 35 is substantially parallel to the base plate 31. A first sliding slot 311 is defined in the base plate 311, and two driving portions 313 are located on an edge of the base plate 31. In at least one embodiment, each driving portion 313 is a piece that is substantially perpendicular to the base plate 31. A second sliding slot 351 is defined in each coupling plate 35, and a second hook 353 is located on each coupling plate 35, configured to secure a second end of the resilient member 40.

A securing member 70 is secured to the storage device 50 by means such as screws, jointing, or clips. In at least one embodiment, the securing member 70 can be integrated with the storage device 50. A securing hole 71 is defined in the securing member 70 and corresponds to the clipping portions 2411. That is, the securing member 70 can extend through the through hole 2151 to engage the clipping portions 2411 in the securing hole 71.

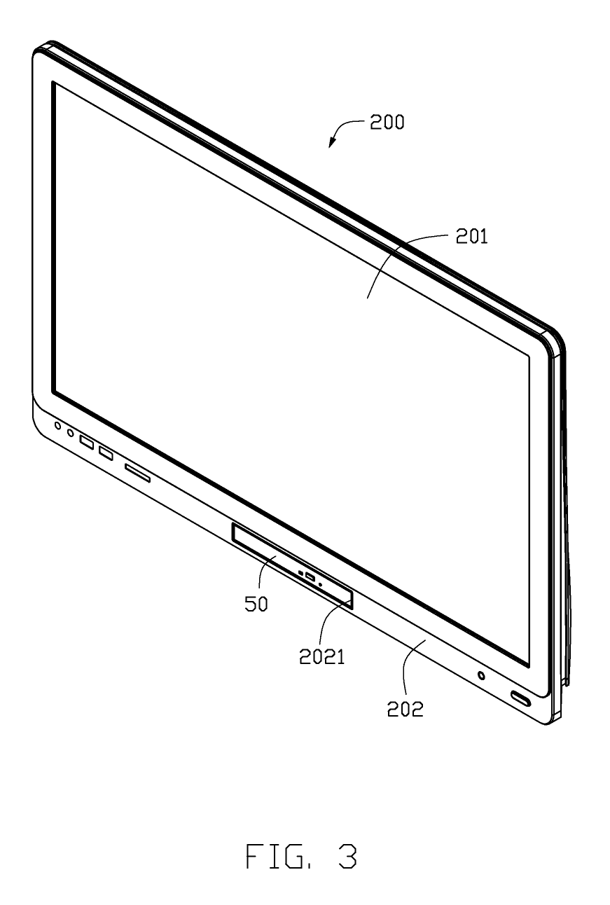

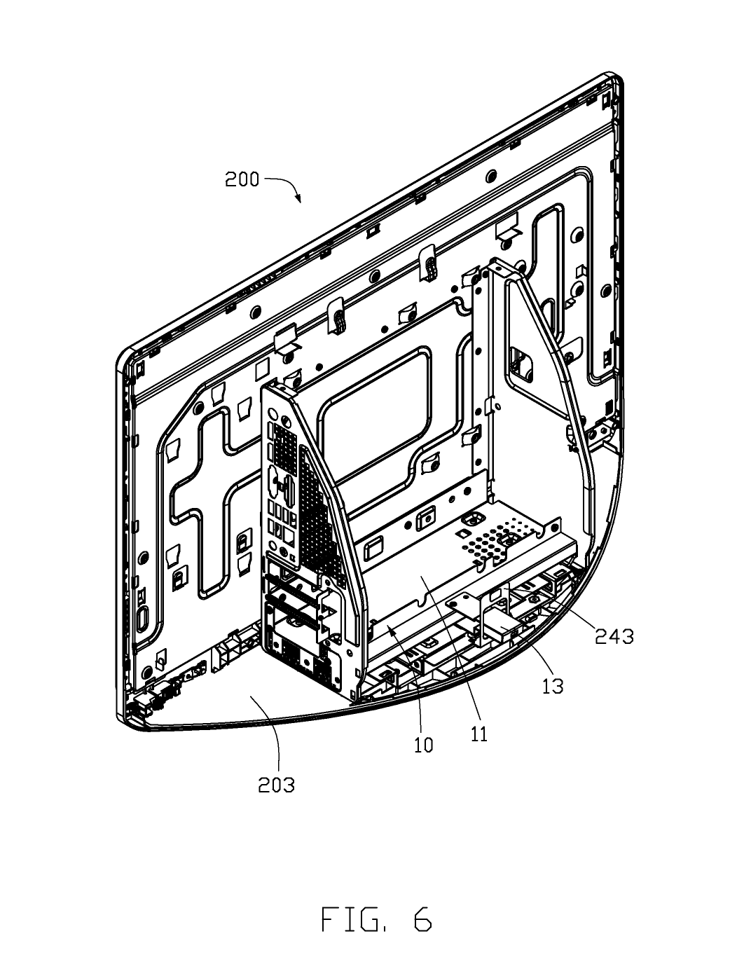

FIGS. 3, 4, and 6 illustrate an embodiment of the mounting apparatus 100 used in an electronic device 200, such as an All-In-One. The electronic device 200 can include a display 201, a front panel 202 below the display 201, and a bottom panel 203 behind the display 201. An opening 2021 is defined in the front panel 202 and is configured to allow the storage device 50 move in and out of the front panel 202. The mounting tray 10 can be secured to the bottom panel 203 by means such as screws, jointing, or clips.

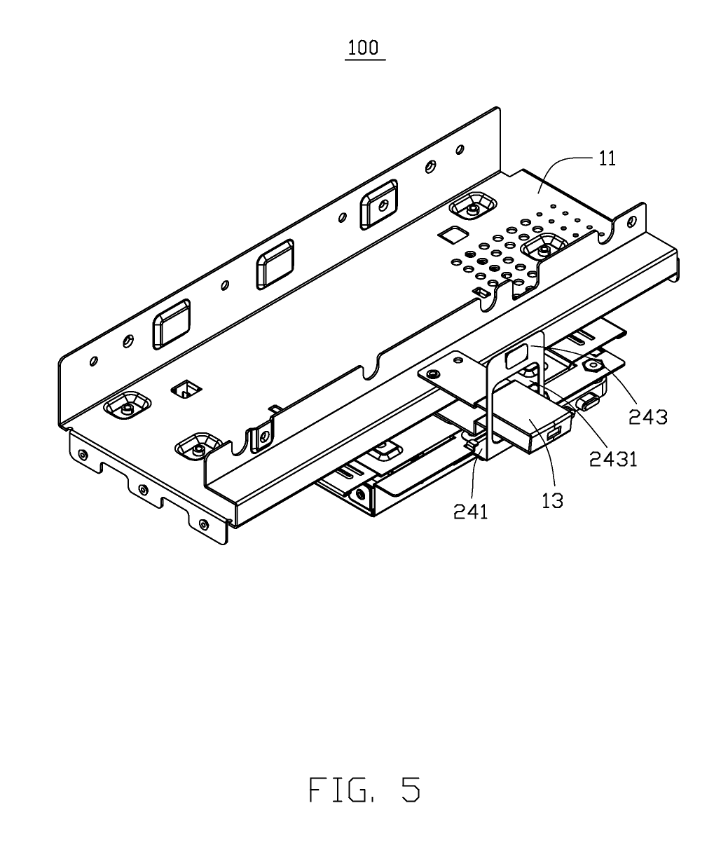

FIGS. 1, 3, 5, and 6 illustrate an assembled view of the mounting apparatus 100. In assembly, the mounting tray 10 is secured to the bottom panel 203 by means such as screws, jointing, or clips. The sliding member 30 is placed on the mounting plate 11, the two protruding posts 112 are slidably received in the first sliding slot 311, and each flange 33 is moveably attached each of the first and second limiting portions 116, 117. Each sliding piece 2131 is slidably received in each second sliding slot 351, and the bracket 20 is secured to the mounting tray 10 by means such as screws, jointing, or clips, allowing the limiting member 13 to engage in the limiting hole 2431. Thus, the sliding member 30 is slidably located between the mounting tray 10 and the bracket 20 and is further received in the receiving space 60. The first end of each resilient member 40 is secured to the first hook 114, and the second end of each resilient member 40 is secured to the second hook 353. Therefore, each resilient member can be secured to the sliding member 30 and the mounting tray 10.

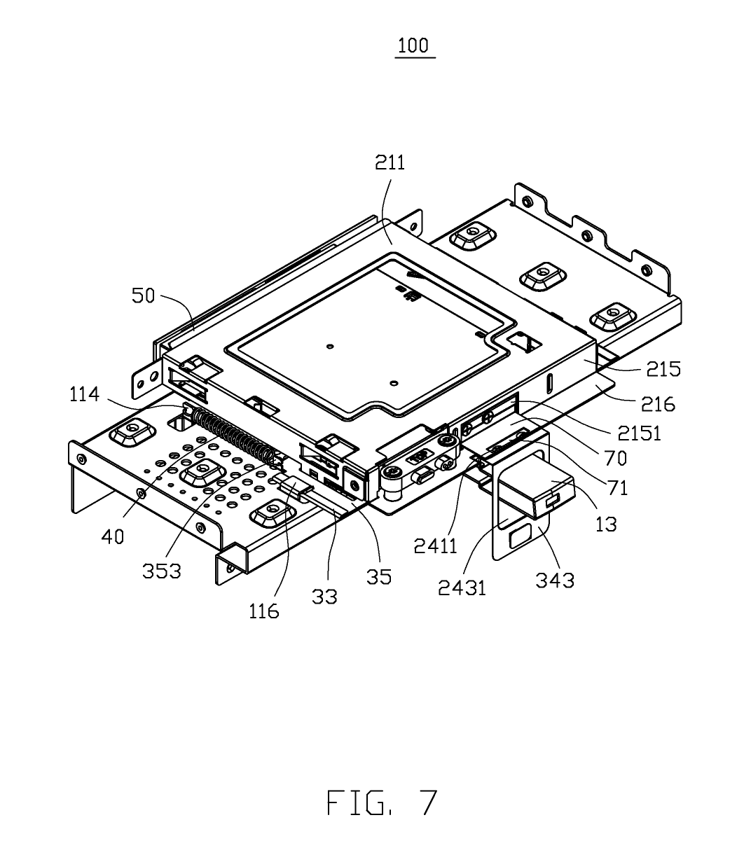

FIGS. 3 and 7 illustrate the assembly of the storage device 50, the storage device 50 extending through the opening 2021 to be located in the receiving space 60. The storage device 50 is moved in a first direction that is substantially parallel to the mounting plate 11, allowing the storage device 50 to slide along the guiding ways 36, until the two driving portions 313 resist the storage device 50. The storage device 50 is further moved in the first direction, and the sliding member 30 is moved in the first direction by the storage device 50. Simultaneously, the two resilient members 40 are deformed by the sliding member 30, the two protruding posts 112 are slid in the first sliding slots 311, and the sliding pieces 2131 are slid in the second sliding slots 351. Until the two driving portions 313 resist the rear plate 215 and the securing member 70 extends through the through hole 2151, the clipping portions 2411 can be engaged in the securing hole 71.

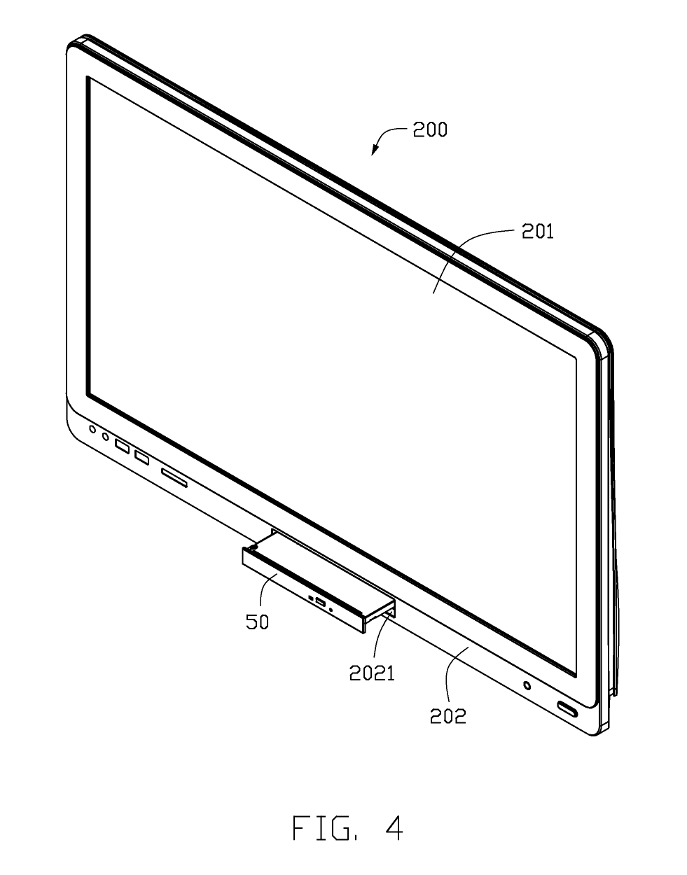

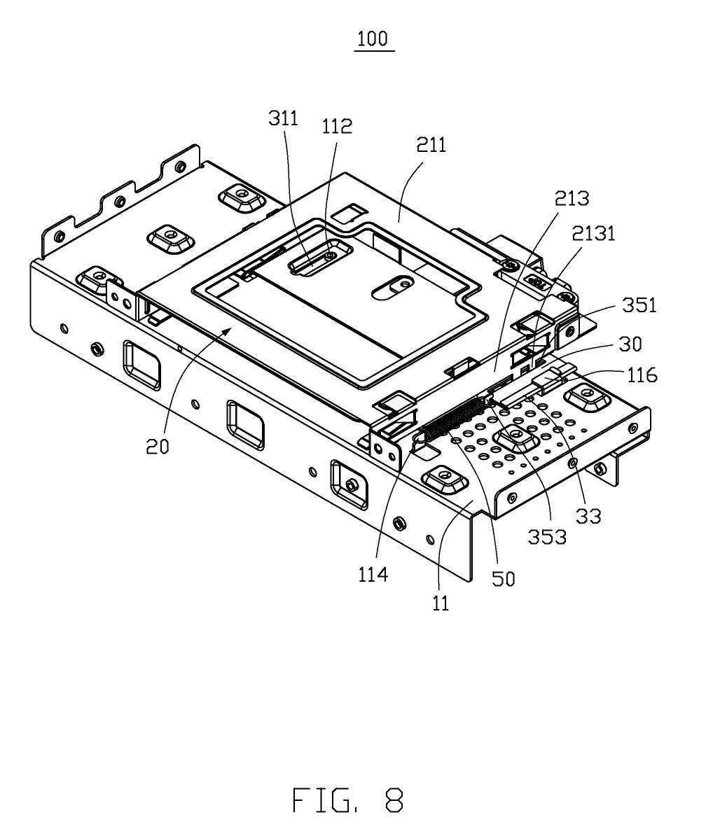

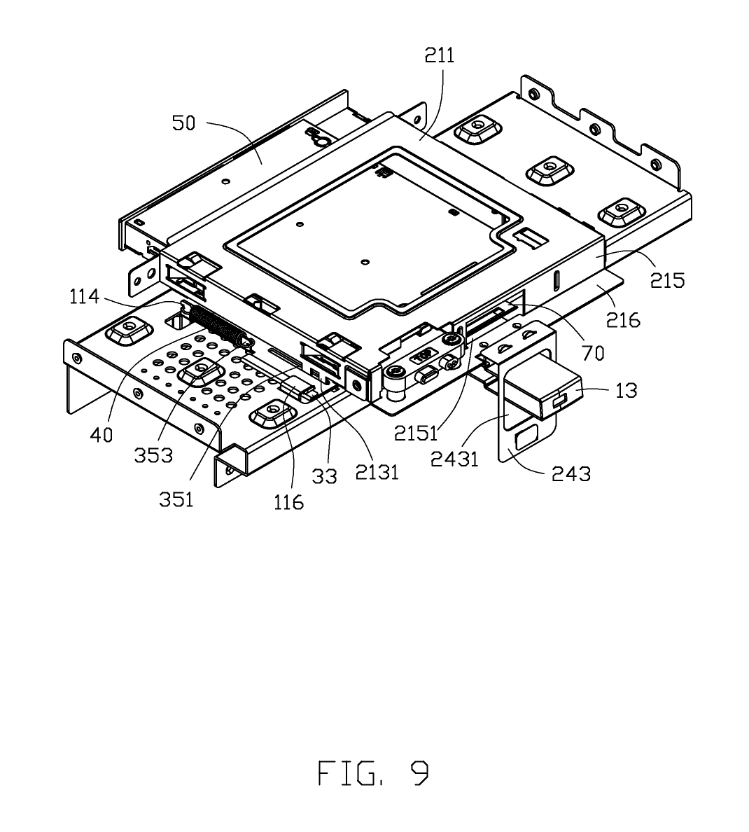

FIGS. 4, 8, and 9 illustrate the disassembly of the storage device 50. The operating piece 243 is operated in a second direction that is substantially perpendicular to the first direction, to disengage the clipping portions 2411 from the securing hole 71. The two resilient members 40 restore to slide the sliding member 30 in a third direction that is substantially opposite to the first direction. Thus, the two driving portions 313 can move the storage device 50 and the securing member 70 in the third direction. The two protruding posts 112 are slid in the first sliding slots 311, and the sliding pieces 2131 are slid in the second sliding slots 351, until the storage device 50 is out of the front panel 202 via the opening 2021. The storage device 50 can thus be removed from the electronic device 200.

The embodiments shown and described above are only examples. Many details are often found in the art such as the other features of an electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A mounting apparatus comprising:
a mounting tray comprising a mounting plate;
a bracket secured to the mounting plate and configured to secure a storage device, the storage device comprising a securing member;
a clipping member located on the bracket; and
a sliding member received in the bracket and slidably located between the bracket and the mounting tray,
wherein the sliding member is slidable relative to the mounting plate and is configured to engage the securing member with the clipping member.

2. The mounting apparatus of claim 1, wherein the bracket comprises a bottom plate and a rear plate coupled to the bottom plate, a through hole is defined in the rear plate, and the securing member extends through the through hole to engage with the clipping member.

3. The mounting apparatus of claim 1, further comprising a resilient member, wherein the resilient member is located between the sliding member and the mounting plate.

4. The mounting apparatus of claim 3, wherein the resilient member is deformed when the securing member is engaged with the clipping member, and the resilient member is rebound to slide the sliding member to disengage the storage device from the bracket.

5. The mounting apparatus of claim 4, wherein the sliding member comprises a driving portion configured for move the storage device, and the driving portion is resisted on the storage device.

6. The mounting apparatus of claim 1, wherein the clipping member comprises a clipping portion, and the clipping portion is configured to clip in a securing hole of the securing member.

7. The mounting apparatus of claim 6, wherein the clipping member comprises a clipping piece and an operating piece substantially perpendicular to the clipping piece, the clipping portion is located on the clipping piece, and the operating piece is configured to disengage the clipping portion from the securing hole.

8. The mounting apparatus of claim 7, wherein the sliding member is slidable in a first direction that is substantially parallel to the mounting plate, and the operating piece is moveable in a second direction that is substantially perpendicular to the first direction.

9. The mounting apparatus of claim 7, wherein a limiting member is located on the mounting tray, a limiting hole is defined in the operating piece, and the limiting member is received in the limiting hole.

10. The mounting apparatus of claim 1, wherein the sliding member comprises a base plate, two flanges, and a coupling plate coupled to each flange and the base plate, each coupling plate is substantially parallel to the base plate, a guiding way is defined the base plate and each coupling plate and is configured for allowing the storage device to sliding along, the mounting plate comprises two limiting portions for receiving the two flange, a sliding slot is defined in the base plate, and a sliding piece is located on the bracket and slidably received in the sliding slot.

11. A mounting apparatus comprising:
a mounting tray comprising a mounting plate;
a bracket secured to the mounting plate and comprising a bottom plate, two side plates, and a rear plate; a receiving space defined by the bottom plate, the two side plates and the rear plate and configured to receiving a storage device; a through hole defined in the rear plate, and an extending plate extending from the rear plate, a clipping member located on the extending plate;
a securing member is configured to be secured to the storage device; and
a sliding member received in the receiving space and slidably located between the bracket and the mounting tray;
wherein the sliding member is configured to abut the storage device, the securing member extends through the through hole to engage with the clipping member.

12. The mounting apparatus of claim 11, wherein the extending plate is substantially perpendicular to the rear plate and is substantially parallel to the bottom plate.

13. The mounting apparatus of claim 11, further comprising a resilient member, wherein the resilient member is located between the sliding member and the mounting plate.

14. The mounting apparatus of claim 13, wherein the resilient member is deformed when the securing member is engaged with the clipping member, and the resilient member is rebound to slide the sliding member to disengage the storage device from the bracket.

15. The mounting apparatus of claim 14, wherein the sliding member comprises a driving portion configured for move the storage device, and the driving portion is resisted on the storage device.

16. The mounting apparatus of claim 11, wherein the clipping member comprises a clipping portion, and the clipping portion is configured to clip in a securing hole of the securing member.

17. The mounting apparatus of claim 16, wherein the clipping member comprises a clipping piece and an operating piece substantially perpendicular to the clipping piece, the clipping portion is located on the clipping piece, and the operating piece is configured to disengage the clipping portion from the securing hole.

18. The mounting apparatus of claim 17, wherein the sliding member is slidable in a first direction that is substantially parallel to the mounting plate, and the operating piece is moveable in a second direction that is substantially perpendicular to the first direction.

19. The mounting apparatus of claim 17, wherein a limiting member is located on the mounting tray, a limiting hole is defined in the operating piece, and the limiting member is received in the limiting hole.

20. The mounting apparatus of claim 11, wherein the sliding member comprises a base plate, two flanges, and a coupling plate coupled to each flange and the base plate, each coupling plate is substantially parallel to the base plate, a guiding way is defined the base plate and each coupling plate and is configured for allowing the storage device to sliding along, the mounting plate comprises two limiting portions for receiving the two flange, a sliding slot is defined in the base plate, and a sliding piece is located on the bracket and slidably received in the sliding slot.
